(19) United States
(12) Patent Application Publication
(10) Pub. No.: US 2026/0159440 A1
(43) Pub. Date: Jun. 11, 2026

(54) GLASS FIBER AND METHOD FOR PRODUCING THE SAME

(71) Applicant: NAN YA PLASTICS CORPORATION, TAIPEI (TW)

(72) Inventors: CHING-YAO YUAN, TAIPEI (TW); WEI-SHENG CHENG, TAIPEI (TW); CHIA-CHEN SU, TAIPEI (TW)

(21) Appl. No.: 19/059,271

(22) Filed: Feb. 21, 2025

(30) Foreign Application Priority Data
Dec. 11, 2024 (TW) 113148014

(51) Int. Cl. C03C 14/00; C03B 37/022; C03C 13/00

(52) U.S. Cl. CPC C03C 14/004; C03C 13/00; C03B 37/022; C03C 2213/00; C03C 2214/05; C03C 2214/30

(57) ABSTRACT

A glass fiber and method for producing the same are provided. The method for producing the glass fiber includes a covering process, a mixing process, and a drawing process. The covering process is implemented by covering a plurality of silicon nitride powders onto a plurality of surfaces of a plurality of inorganic particles to form a plurality of modified inorganic particles. Based on a total weight of each of the modified inorganic particles being 100 wt %, a content of the silicon nitride powders is between 0.01 wt % and 5 wt %, and a content of the inorganic particles is between 95 wt % and 99.99 wt %. The mixing process is implemented by mixing the modified inorganic particles into a glass raw material. The drawing process is implemented by drawing the glass raw material having the modified inorganic particles mixed therein to form a glass fiber.

### CROSS-REFERENCE TO RELATED PATENT APPLICATION

This application claims the benefit of priority to Taiwan Patent Application No. 113148014, filed on Dec. 11, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a glass fiber and method for producing the same, and more particularly to a glass fiber including silicon nitride and method for producing the same.

### BACKGROUND OF THE DISCLOSURE

A glass fiber produced by a conventional method for producing a glass fiber has excessive electrical loss.

### SUMMARY OF THE DISCLOSURE

In response to the above-referenced technical inadequacy, the present disclosure provides a glass fiber and method for producing the same, so as to effectively improve on an issue about a glass fiber produced by a conventional method for producing a glass fiber having excessive electrical loss.

In order to solve the above-mentioned problems, one of the technical aspects adopted by the present disclosure is to provide a method for producing a glass fiber. The method for producing the glass fiber includes a covering process, a mixing process, and a drawing process. The covering process is implemented by covering a plurality of silicon nitride powders onto a plurality of surfaces of a plurality of inorganic particles to form a plurality of modified inorganic particles. Based on a total weight of each of the modified inorganic particles being 100 wt %, a content of the silicon nitride powders is between 0.01 wt % and 5 wt %, and a content of the inorganic particle is between 95 wt % and 99.99 wt %. The mixing process is implemented by mixing the modified inorganic particles into a glass raw material that is in a molten state. The drawing process is implemented by drawing the glass raw material having the modified inorganic particles mixed therein to form a glass fiber. Based on a total weight of the glass fiber being 100 wt %, a content of the modified inorganic particles is between 0.01 wt % and 5 wt %, and a content of the glass raw material is between 95 wt % and 99.99 wt %.

In one of the possible or preferred embodiments, an average particle size of the modified inorganic particles is between 0.01 μm and 50 μm.

In one of the possible or preferred embodiments, based on a total weight of the glass raw material being 100 wt %, the glass raw material includes 52 wt % to 58 wt % of silicon dioxide, 10 wt % to 18 wt % of aluminum oxide, 0.1 wt % to 5 wt % of calcium oxide, 0.1 wt % to 5 wt % of magnesium oxide, 20 wt % to 30 wt % of boron trioxide, 0.1 wt % to 0.3 wt % of ferric oxide, 0.1 wt % to 4 wt % of strontium oxide, and 0.1 wt % to 2 wt % of titanium dioxide.

In one of the possible or preferred embodiments, the inorganic particles are selected from the group consisting of silicon dioxide, titanium dioxide, aluminum hydroxide, magnesium hydroxide, calcium carbonate, aluminum oxide, magnesium oxide, talc, aluminum nitride, boron nitride, silicon carbide, zinc oxide, zirconium oxide, quartz, diamond powder, diamond-like powder, graphite, calcined kaolin, and fumed silica.

In one of the possible or preferred embodiments, in the covering process, a first nitrogen compound is dissolved in first solvent, a first silicon source is added into the first solvent, the first nitrogen compound, the first solvent, and the first silicon source is heated at first heating temperature of between 1200° C. and 1400° C., such that the first nitrogen compound and the first silicon source reacts to form the silicon nitride powders, and then the inorganic particles are added into the silicon nitride powders, such that the silicon nitride powders cover onto the surfaces of the inorganic particles to form the modified inorganic particles.

In one of the possible or preferred embodiments, the first nitrogen compound is urea, the first solvent is water, ethanol, or isopropyl alcohol, and the first silicon source is silicon powders.

In one of the possible or preferred embodiments, in the covering process, a second nitrogen compound is dissolved in a second solvent, a second silicon source is added into the second solvent, the second solvent is stirred to form a gel, the gel is sprayed onto the surfaces of the inorganic particles, and the inorganic particles having the gel formed on the surfaces thereof are heated at a second heating temperature of between 1200° C. and 1400° C., such that the second nitrogen compound and the second silicon source react to form the silicon nitride powders that cover onto the surfaces of the inorganic particles to form the modified inorganic particles.

In one of the possible or preferred embodiments, the second nitrogen source is urea, the second solvent is water, ethanol, or isopropyl alcohol, and the second silicon source is selected from the group consisting of tetraethoxysilane, tetramethoxysilane, and methyltriethoxysilane.

In one of the possible or preferred embodiments, the glass fiber has a dielectric constant (Dk) of between 4.24 and 4.36 measured at a frequency of 10 GHz, and the glass fiber has a dielectric loss rate (Df) of between 0.0017 and 0.0019 measured at a frequency of 10 GHz.

In order to solve the above-mentioned problems, another one of the technical aspects adopted by the present disclosure is to provide a glass fiber. The glass fiber includes a glass raw material and a plurality of modified inorganic particles dispersed in the glass raw material. Each of the modified inorganic particles includes an inorganic particle and a plurality of silicon nitride powders covering on the inorganic particle. Based on a total weight of each of the modified inorganic particles being 100 wt %, a content of the silicon nitride powders is between 0.01 wt % and 5 wt %, and a content of the inorganic particle is between 95 wt % and 99.99 wt %. The inorganic particles are selected from the group consisting of silicon dioxide, titanium dioxide, aluminum hydroxide, magnesium hydroxide, calcium carbonate, aluminum oxide, magnesium oxide, talc, aluminum nitride, boron nitride, silicon carbide, zinc oxide, zirconium oxide, quartz, diamond powder, diamond-like powder, graphite, calcined kaolin, and fumed silica. Based on a total weight of the glass fiber being 100 wt %, a content of the modified inorganic particles is between 0.01 wt % and 5 wt %, and a content of the glass raw material is between 95 wt % and 99.99 wt %.

In one of the possible or preferred embodiments, an average particle size of the modified inorganic particles is between 0.01 μm and 50 μm.

In one of the possible or preferred embodiments, based on a total weight of the glass raw material being 100 wt %, the glass raw material includes 52 wt % to 58 wt % of silicon dioxide, 10 wt % to 18 wt % of aluminum oxide, 0.1 wt % to 5 wt % of calcium oxide, 0.1 wt % to 5 wt % of magnesium oxide, 20 wt % to 30 wt % of boron trioxide, 0.1 wt % to 0.3 wt % of ferric oxide, 0.1 wt % to 4 wt % of strontium oxide, and 0.1 wt % to 2 wt % of titanium dioxide.

In one of the possible or preferred embodiments, the glass fiber has a dielectric constant (Dk) of between 4.24 and 4.36 measured at a frequency of 10 GHz, and the glass fiber has a dielectric loss rate (Df) of between 0.0017 and 0.0019 measured at a frequency of 10 GHz.

Therefore, in the glass fiber and method for producing the same provided by the present disclosure, by virtue of “the covering process the mixing process, and the drawing process,” “based on the content of each of the modified inorganic particles being 100 wt %, the content of the silicon nitride powders being between 0.01 wt % and 5 wt %, and the content of the inorganic particles being 95 wt % and 99.99 wt %,” and “the modified inorganic particles being dispersed in the glass raw material,” the issue about the glass fiber produced by the conventional method for producing the glass fiber having excessive electrical loss can be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for producing a glass fiber according to an embodiment of the present disclosure;

FIG. 2 is a schematic view of a glass fiber according to the embodiment of the present disclosure; and

FIG. 3 is a schematic view of a modified inorganic particle according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Method for Producing a Glass Fiber

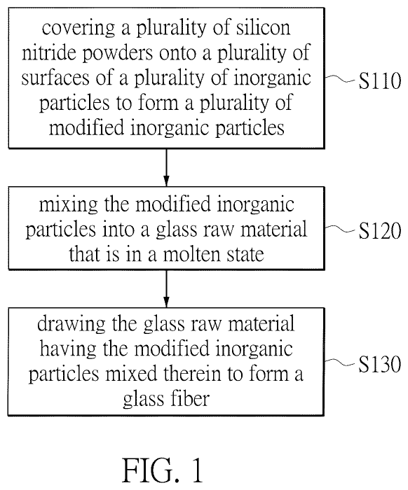

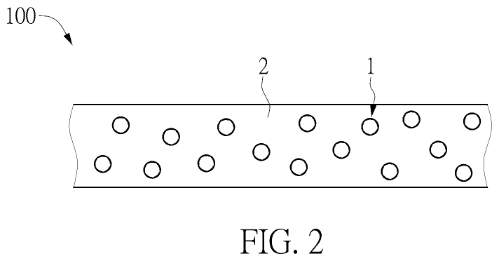

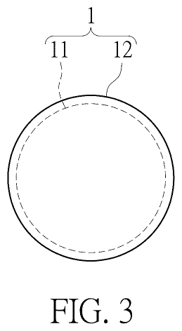

Referring to FIG. 1 to FIG. 3, FIG. 1 is a flowchart of a method for producing a glass fiber according to an embodiment of the present disclosure, FIG. 2 is a schematic view of a glass fiber according to the embodiment of the present disclosure, and FIG. 3 is a schematic view of a modified inorganic particle according to the embodiment of the present disclosure. An embodiment of the present disclosure provides a method for producing a glass fiber, the method for producing the glass fiber includes a covering process S110, a mixing process S120, and a drawing process S130. Naturally, the method for producing the glass fiber can include other processes according to practical requirements, and the present disclosure is not limited thereto.

The covering process S110 is implemented by covering a plurality of silicon nitride powders (e.g., Si₃N₄ powders) onto a plurality of surfaces of a plurality of organic particles to form a plurality of modified inorganic particles 1. Each of the modified inorganic particles 1 has a core-shell structure, the core-shell structure includes a core layer 11 formed by the inorganic particle and a shell layer 12 formed by the silicon nitride powders. Based on a total weight of each of the modified inorganic particles 1 being 100 wt %, a content of the silicon nitride powders is between 0.01 wt % and 5 wt %, and a content of the inorganic particle is between 95 wt % and 99.99 wt %. An average particle size of the modified inorganic particles 1 is between 0.01 μm and 50 um, but the present disclosure is not limited thereto.

It is worth mentioning that, the inorganic particles have a high temperature resistance. Preferably, the inorganic particles are selected from the group consisting of silicon dioxide, titanium dioxide, aluminum hydroxide, magnesium hydroxide, calcium carbonate, aluminum oxide, magnesium oxide, talc, aluminum nitride, boron nitride, silicon carbide, zinc oxide, zirconium oxide, quartz, diamond powder, diamond-like powder, graphite, calcined kaolin, and fumed silica.

In the covering process S110 of one embodiment, a first nitrogen compound is dissolved in first solvent, a first silicon source is added into the first solvent, the first nitrogen compound, the first solvent, and the first silicon source is heated at a first heating temperature of between 1200° C. and 1400° C., such that the first nitrogen compound and the first silicon source reacts to form the silicon nitride powders, and then the inorganic particles are added into the silicon nitride powders, such that the silicon nitride powders cover onto the surfaces of the inorganic particles to form the modified inorganic particles 1.

In other words, in the present embodiment, the silicon nitride powders can cover onto the surfaces of the inorganic powders to form modified inorganic particles 1 in a dry manner. In addition, in the present embodiment, the first nitrogen compound is urea, the first solvent is water, ethanol, or isopropyl alcohol, and the first silicon source is silicon powders, but the present disclosure is not limited thereto.

In the covering process S110 of another embodiment, a second nitrogen compound is dissolved in a second solvent, a second silicon source is added into the second solvent, the second solvent is stirred to form a gel, the gel is sprayed onto the surfaces of the inorganic particles, and the inorganic particles having the gel formed on the surfaces thereof are heated at a second heating temperature of between 1200° C. and 1400° C., such that the second nitrogen compound and the second silicon source react to form the silicon nitride powders that cover onto the surfaces of the inorganic particles to form the modified inorganic particles 1. It is worth mentioning that, in the covering process S110 of the present embodiment, the second nitrogen compound and the silicon source react on the inorganic particles to form the silicon nitride powders.

In other words, in the present embodiment, the silicon nitride powders can cover onto the surfaces of the inorganic powders to form modified inorganic particles 1 in a wet manner. In addition, in the present embodiment, the second nitrogen source is urea, the second solvent is water, ethanol, or isopropyl alcohol, and the second silicon source is selected from the group consisting of tetraethoxysilane (TEOS), tetramethoxysilane (TMOS), and methyltriethoxysilane (MTES), but the present disclosure is not limited thereto.

The mixing process S120 is implemented by mixing the modified inorganic particles 1 into a glass raw material 2 that is in a molten state. Based on a total weight of the glass raw material being 100 wt %, the glass raw material includes 52 wt % to 58 wt % of silicon dioxide, 10 wt % to 18 wt % of aluminum oxide, 0.1 wt % to 5 wt % of calcium oxide, 0.1 wt % to 5 wt % of magnesium oxide, 20 wt % to 30 wt % of boron trioxide, 0.1 wt % to 0.3 wt % of ferric oxide, 0.1 wt % to 4 wt % of strontium oxide, and 0.1 wt % to 2 wt % of titanium dioxide, but the present disclosure is not limited thereto.

The drawing process S130 is implemented by drawing the glass raw material 2 having the modified inorganic particles 1 mixed therein to form a glass fiber 100. Based on a total weight of the glass fiber 100 being 100 wt %, a content of the modified inorganic particles 1 is between 0.01 wt % and 5 wt %, and a content of the glass raw material 2 is between 95 wt % and 99.99 wt %.

Silicon nitride has low a dielectric loss property, especially in a high frequency application. Silicon nitride has good stability under a high-frequency electric field, and polarization is weak, thereby reducing the electrical energy loss of the glass fiber. Accordingly, the glass fiber 100 has a dielectric constant (Dk) of between 4.24 and 4.36 measured at a frequency of 10 GHz, and the glass fiber 100 has a dielectric loss rate (Df) of between 0.0017 and 0.0019 measured at a frequency of 10 GHz.

### Glass Fiber

The embodiment of the present embodiment further provides a glass fiber 100. The glass fiber 100 can be obtained by implementing the above-mentioned method for producing the glass fiber, but the present disclosure is not limited thereto.

The glass fiber 100 includes a glass raw material 2 and a plurality of modified inorganic particles 1 dispersed in the glass raw material 2. Each of the modified inorganic particles 1 includes an inorganic particle and a plurality of silicon nitride powders covering on the inorganic particle. Based on a total weight of each of the modified inorganic particles being 100 wt %, a content of the silicon nitride powders is between 0.01 wt % and 5 wt %, and a content of the inorganic particle is between 95 wt % and 99.99 wt %.

The inorganic particles are selected from the group consisting of silicon dioxide, titanium dioxide, aluminum hydroxide, magnesium hydroxide, calcium carbonate, aluminum oxide, magnesium oxide, talc, aluminum nitride, boron nitride, silicon carbide, zinc oxide, zirconium oxide, quartz, diamond powder, diamond-like powder, graphite, calcined kaolin, and fumed silica. An average particle size of the modified inorganic particles 1 is between 0.01 μm and 50 μm, but the present disclosure is not limited thereto.

Based on a total weight of the glass fiber 100 being 100 wt %, a content of the modified inorganic particles is between 0.01 wt % and 5 wt %, and a content of the glass raw material is between 95 wt % and 99.99 wt %, but the present disclosure is not limited thereto.

Based on a total weight of the glass raw material 2 being 100 wt %, the glass raw material 2 includes 52 wt % to 58 wt % of silicon dioxide, 10 wt % to 18 wt % of aluminum oxide, 0.1 wt % to 5 wt % of calcium oxide, 0.1 wt % to 5 wt % of magnesium oxide, 20 wt % to 30 wt % of boron trioxide, 0.1 wt % to 0.3 wt % of ferric oxide, 0.1 wt % to 4 wt % of strontium oxide, and 0.1 wt % to 2 wt % of titanium dioxide, but the present disclosure is not limited thereto.

The glass fiber has a dielectric constant (Dk) of between 4.24 and 4.36 measured at a frequency of 10 GHz, and the glass fiber has a dielectric loss rate (Df) of between 0.0017 and 0.0019 measured at a frequency of 10 GHz.

### Experimental Results

Hereinafter, a more detailed description will be provided with reference to Exemplary Examples 1 to 8 and Comparative Example 1. However, the following Exemplary Examples are only used to aid in understanding of the present disclosure, and are not to be construed as limiting the scope of the present disclosure.

In Comparative Example 1, no modified inorganic particle is added. In the glass fibers of Exemplary Examples 1 to 4, based on the total weight of each of the glass fibers being 100 wt %, the contents of the modified inorganic particles are respectively 0.01 wt %, 0.05 wt %, 0.1 wt %, and 1 wt %, and the contents of the glass raw materials are respectively 99.99 wt %, 99.95 wt %, 99.9 wt %, and 99 wt %.

In Exemplary Example 5, the silicon nitride powders cover onto the inorganic particles in a dry manner, in Exemplary Example 6, the silicon nitride powders cover onto the inorganic particle in a wet manner, and in Exemplary Examples 6 to 8, tetraethoxysilane (TEOS), tetramethoxysilane (TMOS), and methyltriethoxysilane (MTES) are respectively used as the silicon source. In Exemplary Examples 5 to 8, based on the total weight of each of the glass fibers being 100 wt %, the content of the modified inorganic particles is 0.1 wt %, and the content of the glass raw materials is 99.9 wt %.

The dielectric constant (Dk) and the dielectric loss rate (Df) is measured by the dielectric analyzer (made by Keysight Technologies) at a frequency of 10 GHz.

TABLE 1
[Glass Fibers Including Modified Inorganic Particles with Different
Contents and Dielectric Constant and Dielectric Loss Rate thereof]

| | Compar- | | | | |
|---|---|---|---|---|---|
| | ative | Exemplary | Exemplary | Exemplary | Exemplary |
| Item | Example 1 | Example 1 | Example 2 | Example 3 | Example 4 |
| Content of | 0 | 0.01 | 0.05 | 0.1 | 1 |
| modified | | | | | |
| inorganic | | | | | |
| particles | | | | | |
| (wt %) | | | | | |
| Dk(10 GHz) | 5.3 | 4.30 | 4.24 | 4.36 | 4.28 |
| Df(10 GHz) | 0.0067 | 0.00176 | 0.00170 | 0.00178 | 0.0019 |

TABLE 2
[Glass Fibers Produced by Different Covering Manners
and Dielectric Constant and Dielectric Loss Rate thereof]

| | Compar- | | | | |
|---|---|---|---|---|---|
| | ative | Exemplary | Exemplary | Exemplary | Exemplary |
| Item | Example 1 | Example 5 | Example 6 | Example 7 | Example 8 |
| Covering | None | Dry | Wet | Wet | Wet |
| manner | | manner | manner | manner | manner |
| Content of | 0 | 0.1 | 0.1 | 0.1 | 0.1 |
| modified | | | | | |
| inorganic | | | | | |
| particles | | | | | |
| (wt %) | | | | | |
| Material | None | CO(NH₂)₂ | CO(NH₂)₂ | CO(NH₂)₂ | CO(NH₂)₂ |
| of nitrogen | | | | | |
| compound | | | | | |
| Material | None | Silicon | TEOS | TMOS | MTES |
| of silicon | | powders | | | |
| source | | | | | |
| Dk(10 GHz) | 5.3 | 4.30 | 4.24 | 4.36 | 4.28 |
| Df(10 GHz) | 0.0067 | 0.00176 | 0.0017 | 0.00178 | 0.0019 |

### Discussion of Test Results

As shown in Comparative Example 1 and Exemplary Examples 1 to 4, the glass fiber of Comparative Example 1 is not added with modified inorganic powders, and accordingly, the dielectric constant and the dielectric loss rate of the glass fiber are relatively high. As shown in Comparative Example 1 and Exemplary Examples 5 to 8, the silicon nitride powders can cover onto the inorganic particles in the dry manner or in the wet manner, and tetraethoxysilane, tetramethoxysilane, and methyltriethoxysilane can be used as the silicon source in the wet manner.

### Beneficial Effects of the Embodiment

In conclusion, in the glass fiber and method for producing the same provided by the present disclosure, by virtue of “the covering process the mixing process, and the drawing process,” “based on the content of each of the modified inorganic particles being 100 wt %, the content of the silicon nitride powders being between 0.01 wt % and 5 wt %, and the content of the inorganic particles being 95 wt % and 99.99 wt %,” and “the modified inorganic particles being dispersed in the glass raw material,” the issue about the glass fiber produced by the conventional method for producing the glass fiber having excessive electrical loss can be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing a glass fiber, comprising:
a covering process implemented by covering a plurality of silicon nitride powders onto a plurality of surfaces of a plurality of inorganic particles to form a plurality of modified inorganic particles; wherein, based on a total weight of each of the modified inorganic particles being 100 wt %, a content of the silicon nitride powders is between 0.01 wt % and 5 wt %, and a content of the inorganic particle is between 95 wt % and 99.99 wt %;
a mixing process implemented by mixing the modified inorganic particles into a glass raw material that is in a molten state; and
a drawing process implemented by drawing the glass raw material having the modified inorganic particles mixed therein to form a glass fiber;
wherein, based on a total weight of the glass fiber being 100 wt %, a content of the modified inorganic particles is between 0.01 wt % and 5 wt %, and a content of the glass raw material is between 95 wt % and 99.99 wt %.

2. The method according to claim 1, wherein an average particle size of the modified inorganic particles is between 0.01 μm and 50 μm.

3. The method according to claim 1, wherein, based on a total weight of the glass raw material being 100 wt %, the glass raw material includes 52 wt % to 58 wt % of silicon dioxide, 10 wt % to 18 wt % of aluminum oxide, 0.1 wt % to 5 wt % of calcium oxide, 0.1 wt % to 5 wt % of magnesium oxide, 20 wt % to 30 wt % of boron trioxide, 0.1 wt % to 0.3 wt % of ferric oxide, 0.1 wt % to 4 wt % of strontium oxide, and 0.1 wt % to 2 wt % of titanium dioxide.

4. The method according to claim 1, wherein the inorganic particles are selected from the group consisting of silicon dioxide, titanium dioxide, aluminum hydroxide, magnesium hydroxide, calcium carbonate, aluminum oxide, magnesium oxide, talc, aluminum nitride, boron nitride, silicon carbide, zinc oxide, zirconium oxide, quartz, diamond powder, diamond-like powder, graphite, calcined kaolin, and fumed silica.

5. The method according to claim 1, wherein, in the covering process, a first nitrogen compound is dissolved in first solvent, a first silicon source is added into the first solvent, the first nitrogen compound, the first solvent, and the first silicon source is heated at first heating temperature of between 1200° C. and 1400° C., such that the first nitrogen compound and the first silicon source reacts to form the silicon nitride powders, and then the inorganic particles are added into the silicon nitride powders, such that the silicon nitride powders cover onto the surfaces of the inorganic particles to form the modified inorganic particles.

6. The method according to claim 5, wherein the first nitrogen compound is urea, the first solvent is water, ethanol, or isopropyl alcohol, and the first silicon source is silicon powders.

7. The method according to claim 1, wherein, in the covering process, a second nitrogen compound is dissolved in a second solvent, a second silicon source is added into the second solvent, the second solvent is stirred to form a gel, the gel is sprayed onto the surfaces of the inorganic particles, and the inorganic particles having the gel formed on the surfaces thereof are heated at a second heating temperature of between 1200° C. and 1400° C., such that the second nitrogen compound and the second silicon source react to form the silicon nitride powders that cover onto the surfaces of the inorganic particles to form the modified inorganic particles.

8. The method according to claim 7, wherein the second nitrogen source is urea, the second solvent is water, ethanol, or isopropyl alcohol, and the second silicon source is selected from the group consisting of tetraethoxysilane, tetramethoxysilane, and methyltriethoxysilane.

9. The method according to claim 1, wherein the glass fiber has a dielectric constant (Dk) of between 4.24 and 4.36 measured at a frequency of 10 GHz, and the glass fiber has a dielectric loss rate (Df) of between 0.0017 and 0.0019 measured at a frequency of 10 GHz.

10. A glass fiber, comprising:
a glass raw material; and
a plurality of modified inorganic particles dispersed in the glass raw material; wherein each of the modified inorganic particles includes an inorganic particle and a plurality of silicon nitride powders covering on the inorganic particle; wherein, based on a total weight of each of the modified inorganic particles being 100 wt %, a content of the silicon nitride powders is between 0.01 wt % and 5 wt %, and a content of the inorganic particle is between 95 wt % and 99.99 wt %;
wherein, the inorganic particles are selected from the group consisting of silicon dioxide, titanium dioxide, aluminum hydroxide, magnesium hydroxide, calcium carbonate, aluminum oxide, magnesium oxide, talc, aluminum nitride, boron nitride, silicon carbide, zinc oxide, zirconium oxide, quartz, diamond powder, diamond-like powder, graphite, calcined kaolin, and fumed silica; and
wherein, based on a total weight of the glass fiber being 100 wt %, a content of the modified inorganic particles is between 0.01 wt % and 5 wt %, and a content of the glass raw material is between 95 wt % and 99.99 wt %.

11. The glass fiber according to claim 10, wherein an average particle size of the modified inorganic particles is between 0.01 μm and 50 um.

12. The method according to claim 10, wherein, based on a total weight of the glass raw material being 100 wt %, the glass raw material includes 52 wt % to 58 wt % of silicon dioxide, 10 wt % to 18 wt % of aluminum oxide, 0.1 wt % to 5 wt % of calcium oxide, 0.1 wt % to 5 wt % of magnesium oxide, 20 wt % to 30 wt % of Boron trioxide, 0.1 wt % to 0.3 wt % of ferric oxide, 0.1 wt % to 4 wt % of strontium oxide, and 0.1 wt % to 2 wt % of titanium dioxide.

13. The method according to claim 10, wherein the glass fiber has a dielectric constant (Dk) of between 4.24 and 4.36 measured at a frequency of 10 GHz, and the glass fiber has a dielectric loss rate (Df) of between 0.0017 and 0.0019 measured at a frequency of 10 GHz.
